(19) United States
(12) Patent Application Publication
(10) Pub. No.: US 2010/0081727 A1
(43) Pub. Date: Apr. 1, 2010

(54) PROCESS FOR PREPARING ENE ADDUCTS

(75) Inventors: Phillip Hanefeld, Heidelberg (DE); Christian Pilger, Ludwigshafen (DE); Klaus Kuehling, Ellerstadt (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, Ludwigshafen (DE)

(21) Appl. No.: 12/597,009

(22) PCT Filed: Apr. 21, 2008
(86) PCT No.: PCT/EP08/54784

§ 371 Date: Oct. 22, 2009

(30) Foreign Application Priority Data
Apr. 27, 2007 (EP) 07107141.9

(51) Int. Cl. C08F 2/46; C08F 255/10

(52) U.S. Cl. 522/120; 525/298; 525/301

(57) ABSTRACT

Preparation of ene adducts, especially polyisobutylsuccinic anhydrides, by thermally reacting olefins (“enes”), especially polyisobutylenes, with vinylic carbonyl compounds (“enophiles”), especially maleic anhydride, using microwave radiation.

The present invention relates to an improved process for preparing ene adducts by thermal reaction of olefins (“enes”) such as linear or branched long-chain α-olefins with vinylic carbonyl compounds (“enophiles”) such as maleic acid, fumaric acid or the anhydrides thereof. In particular, it is advantageously possible by the process according to the invention to prepare polyisobutylsuccinic anhydrides (“PIBSAs”).

Typically, PIBSAs are prepared by thermal reaction of polyisobutenes, especially high-reactivity polyisobutenes, with maleic acid or maleic anhydride with direct heating with an external heat source such as a heating bath, as described, for example, in DE-A 27 02 604 (1). Such reactions can also be performed on the industrial scale.

Such reactions, however, almost never proceed without a certain level of occurrence of impurities and undesired by-products. For example, the formation of undesired dimaleated polyisobutenes is virtually impossible to suppress; the content of dimaleated polyisobutenes in the reaction product is generally from a few % by weight to approx. 50% by weight. What is more troublesome, however, is the formation of tarlike particles which arise mainly through carbonization, which can be removed from the reaction product only by filtration.

The preparation of PIBSAs by a thermal route and also of ene adducts in general is therefore in need of improvement; in particular, higher conversions, purer products without impurities and undesired by-products, and also more uniform product structures are desired, which positively influences, for example, also the subsequent reaction of the PIBSAs to corresponding derivatives suitable as fuel and lubricant additives and increases their quality, especially the active substance content in these derivatives. It was thus an object of the present invention to provide an improved synthesis for ene adducts, especially for polyisobutylsuccinic anhydrides.

Accordingly, an improved process has been found for preparing ene adducts by thermal reaction of olefins (“enes”) with vinylic carbonyl compounds (“enophiles”), which comprises performing the reaction using microwave radiation.

So-called “microwave-supported organic syntheses” are preparation methods which have been established for a few years, especially on the laboratory scale, for a series of organic compounds. A comprehensive review of these synthesis methods for laboratory use is given by C. Oliver Kappe in Angew. Chemie 2004, 116, pages 6408-6443 (2).

R. Laurant, A. Laporterie, J. Dubac, J. Berlan, S. Lefeuvre and M. Audhuy describe, in J. Org. Chem. 1992, 57, pages 7099-7102 (3), results of microwave-supported ene reactions of carbonyl enophiles with olefins. For instance, the authors studied the reaction of diethyl mesoxalate with 1-decene and with β-pinene, and the intramolecular cyclization of citronellal in an open reaction apparatus with use of microwave radiation compared to direct heating with an external heat source. In all cases, it was found that the conversion and the product distribution are not influenced by the use of microwave radiation compared to direct heating with an external heat source. The microwave method apparently did not bring any advantages for the ene reactions studied here.

The benefit of the present invention is to have overcome the prejudice established by the authors of article (3) with regard to the applicability of microwave technology for ene reactions and to have clearly indicated the advantages of microwave technology for the thermal ene reaction of olefins with vinylic carbonyl compounds.

Microwave radiation is electromagnetic radiation in the frequency range from 0.3 to 300 GHz. Owing to the worldwide utilization of microwave radiation in the sector of communications technology, according to international agreements for the further applications, only a few frequency ranges are approved, specifically 433.92 MHz, 915 MHz, 2.45 GHz, 5.80 GHz and 24.125 GHz (so-called “ISM” frequencies: “frequencies for industrial, scientific and medical use”). Among these, the frequency 2.45 GHz (corresponding to a wavelength of 12.24 cm) is the most widespread.

The acceleration of chemical reactions by microwave radiation is based on the efficient and readily controllable energy transfer to reaction media and reaction mixtures by dielectric heating with microwaves. This phenomenon is based on the ability of particular substances (solvents, reagents) to absorb microwave energy and to convert it to heat. The electrical component of an electromagnetic field brings about the heating mainly through dipolar polarization and ion conduction. On irradiation with microwave frequencies, the dipoles or ions of the sample become aligned in the applied field. This field oscillates and, since the dipole or ion field attempts to realign itself with the alternating electrical field, energy is released in the form of heat as a result of molecular friction and dielectric loss. The heating characteristics of a particular substance or medium depend on its dielectric properties; to a first approximation, the dielectric constant is a measure thereof. Polar substances are generally more readily heatable by microwave radiation than nonpolar substances.

Compared to the heating induced by microwave radiation, conventional heating by direct heating with an external heat source, for example a flame or an oil bath, is comparatively slow and inefficient, since conventional heating depends on the thermal conductivity of the substances to be penetrated, which can lead to the temperature of the reaction vessel being higher than that of the reaction mixture. In contrast, in the case of microwave irradiation, heating is effected “from the inside” by virtue of the microwave energy being transmitted directly to the molecules in the reaction mixture.

The materials for the reaction vessels used in the microwave irradiation are generally nonpolar and hence transparent or virtually transparent to microwaves. Typical materials are quartz, ceramics, mica, high-purity aluminum oxide (corundum), some specific glass types such as borosilicate glass, and in particular plastics such as fluoropolymers, e.g. polytetrafluoroethylene (Teflon). The internal heat transfer minimizes wall effects and overheating of vessel surfaces.

In the initial period of scientific microwave technology, mainly domestic microwave ovens were used for chemical syntheses which were performed on the gram scale. Industry now supplies specially developed microwave reactors for the needs of the chemical industry, which allow batch sizes up to the kilogram scale. Owing to the relatively low penetration depth of microwave radiation into material which absorbs it, which is typically in the order of magnitude of centimeters, limits are, however, placed on the dimensions of such microwave reactors. The development of microwave reactors for the industrial scale, i.e. for batch sizes on the ton scale, in spite of the problem of the penetration depth of the radiation, is, however, already sufficiently far advanced that microwave technology will move into industrial chemical production within a few years.

A distinction is drawn between multimode and monomode microwave reactors. Multimode reactors are constructed like domestic microwave ovens: the microwaves which enter the reaction chamber are reflected by the walls and the charge through the normally large interior. In most units, a mode stirrer ensures that the field is distributed very homogeneously. In the relatively small interiors of the monomode reactors, the electromagnetic radiation is directed by a usually exactly rectangular or circular waveguide onto the reaction vessel which is mounted at a fixed distance from the radiation source, so as to give rise to a standing wave.

Microwave radiation is generated in the reactors typically in velocity-modulated tubes, especially in klystrons or magnetrons. The radiation can be released in pulsed or unpulsed form. The microwave power input can in principle be effected over a wide range; typical values are from 200 to 1200 watts, especially from 250 to 1000 watts, in particular from 300 to 600 watts. When the reactions proceed exothermically, the above-specified watt ranges apply to the heating phase; in the course of the exothermic reaction, the power input then levels off at lower wattages to maintain the temperature.

The chemical reactions in microwave reactors can be performed in open or closed reaction vessels. Open reaction vessels are, for example, glass flasks with attached reflux condensers. In particular, however, apparatus which can work with closed reaction vessels such as autoclaves and flow reactors is of interest for chemical synthesis. With the apparatus and techniques currently available, which are in most cases computer-controlled, it is possible to control and monitor temperature and pressure reliably in closed reaction vessels, such that no safety risks occur. Since the microwave field in the reaction vessel can be inhomogeneous, a stirrer device is generally needed for mixing in batchwise apparatus such as glass flasks and autoclaves; in the case of flow reactors, sufficient mixing is typically effected automatically through the flow of the reaction medium.

Since the boiling point of the most volatile components—usually the solvent—is no longer the temperature-limiting factor in closed reaction vessels, the superheating method is typically employed in such microwave-supported organic syntheses in order to accelerate the reaction on the basis of the elevated reaction temperature and to complete the conversion within a shorter time. In this case, reaction temperatures which may be up to 100° C. higher than the boiling point of solvents present at standard pressure are typically achievable; according to the solvents used, it is thus possible to work at reaction temperatures of 300° C. or more.

All aforementioned microwave reactors are suitable in principle for the performance of the present invention. In a preferred embodiment, the process according to the invention, however, is performed in a closed reaction vessel, especially in an autoclave or a flow reactor with pressurization and pressure control. The pressurization in a closed reaction vessel can be effected through autogenous pressure as a consequence of heating in the sealed volume or by means of previously separately added gaseous or liquid substances which may be inert or constitute reaction components.

A closed reaction vessel is also preferred especially when the intention is to prevent feedstocks or products from being depleted by sublimation during the reaction in an open vessel, as is the case, for example, when sublimable maleic anhydride is used as the enophile.

One possible embodiment of a flow reactor with pressurization and pressure controls is a closed reservoir tank which can in principle have any dimensions and has a circulation loop into which the microwave-generating unit is installed. The microwave-supported chemical reaction thus proceeds in the circulation loop which can be of small dimensions. The reaction medium in the reservoir tank is pumped in circulation through the circulation loop until the desired conversion is achieved.

By definition, ene adducts are prepared by the addition (“ene reaction”) of an olefin with allylic double bond (“ene”) and the π bond of an unsaturated compound (“enophile”), for example a C═C, C≡C, C═O, C═S or N═N bond. The reaction proceeds thermally, i.e. by supplying heat. In the present invention, vinylic carbonyl compounds function as the enophile; what is meant here thereby is compounds having the structural element C═C—C═O, C≡C—C═O or N═N—CO. The olefin is generally added onto the carbon or nitrogen atom in the β position to the carbonyl carbon atom, which shifts the double bond of the olefin to the allylic carbon atom in the ene.

The olefins (“enes”) used for the process according to the invention may in principle be all short- or long-chain organic compounds having at least one appropriately reactive allylic double bond. The enes used are preferably linear or branched olefins having from 6 to 4000, especially from 8 to 1000, in particular from 10 to 400, carbon atoms, or mixtures of such olefins. Useful olefins here are in principle all linear, branched and also cyclic olefins having at least one such allylic double bond. Typical examples of such olefins are especially alkenes such as propene, 1-butene, 2-butene, isobutene, 1-pentene, 2-pentene, isopentene, 1-hexene, 1-heptene, 1-octene, 1-nonene, 1-decene, 1-undecene, 1-dodecene, 1-tridecene, isotridecene, 1-tetradecene, 1-pentadecene, 1-hexadecene, 1-heptadecene, 1-octadecene, 1-nonadecene or 1-eicosene. Also suitable are cyclic olefins such as cyclohexene or especially also terpenes, which, as formal dimers of isoprene, are open-chain mono- or polycyclic systems having 10 carbon atoms, for example ocimene, myrcene, terpinenes, terpinolene, phellandrenes, limonene or pinenes.

In a particularly preferred embodiment of the process according to the invention, the enes used are linear or branched α-olefins having from 6 to 4000, especially from 8 to 1000, in particular from 10 to 400, carbon atoms or mixtures of such olefins which comprise α-double bonds to an extent of at least 60 mol %, especially to an extent of at least 70 mol %, in particular to an extent of at least 75 mol %.

In a very particularly preferred embodiment of the process according to the invention, the enes used are high-reactivity polyisobutenes having a number-average molecular weight Mₙ of from 350 to 50 000, especially from 500 to 5000, and a content of at least 70 mol %, especially at least 75 mol %, in particular at least 80 mol %, of α-double bonds.

The PIBSAs thus prepared thus result from polyisobutenes which have a very high activity for the reaction with corresponding enophiles such as maleic acid or maleic anhydride. In this reaction, the olefinic end groups of the formula A (α-double bonds or terminal vinylidene double bonds) in the polyisobutenes in particular are amenable to the reaction with enophiles such as maleic acid or maleic anhydride. For this reason, polyisobutenes having a maximum content of terminal vinylidene double bonds (formula A) are particularly suitable as a starting material for the PIBSAs. Olefinic double bonds further into the molecule, such as β-double bonds of the formula B and γ-double bonds of the formula C, are generally less amenable or not amenable to the reaction with enophiles such as maleic acid or maleic anhydride.

—CH₂—C(CH₃)₂—CH₂—C(CH₃)═CH₂ (A)

CH₂—C(CH₃)₂—CH═C(CH₃)₂ (B)

—CH₂—C(CH₃)═C(CH₃)—CH(CH₃)₂ (C)

The prior art teaches the preparation of polyisobutenes having high contents of terminal double bonds by cationic polymerization of isobutene or isobutenic hydrocarbon streams in the presence of boron trifluoride catalyst complexes, for example in document (1) or in EP-A 632 061 (4). Contents of terminal double bonds of up to 90 mol % are achieved there.

The preparation of high-reactivity polyisobutenes having a content of terminal vinylidene double bonds of generally more than 90 mol % is described in the international patent application PCT/EP2006/068468 (5). The polymerization of isobutene in the liquid phase in the presence of particular dissolved, dispersed or supported metal-containing catalyst complexes which may be present in protic acid form is described there; typical metals therein are boron or aluminum. Such high-reactivity polyisobutenes are likewise suitable as enes for the process according to the invention.

The preparation of further high-reactivity polyisobutenes which are suitable as enes for the process according to the invention and have a content of terminal vinylidene double bonds of generally more than 90 mol % is described in European patent application 06 122 522.3 (6). These high-reactivity polyisobutenes are prepared by dehydrohalogenation of polyisobutyl halides with heating in the presence of a solvent having a dielectric constant c of less than 3.

High-reactivity polyisobutenes as should be understood as reactants in the context of the present invention are formed entirely or predominantly from isobutene units. When they consist to an extent of from 98 to 100 mol % of isobutene units, isobutene homopolymers are present. However, it is also possible for up to 20 mol % of 1-butene units to be incorporated into the polymer strand without the properties of the high-reactivity polyisobutene changing significantly as a result. Moreover, up to 5 mol % of further olefinically unsaturated C₄ monomers, such as 2-butenes or butadienes, may also be incorporated as units without the properties of the high-reactivity polyisobutene changing fundamentally as a result.

For the use of isobutene or an isobutenic monomer mixture as the monomer to be polymerized in one of the abovementioned polyisobutene preparation processes, the isobutene source used, as well as pure isobutene, may also be a technical C₄ hydrocarbon stream, preferably having an isobutene content of from 1 to 80% by weight. Suitable for this purpose are especially C₄ raffinates (raffinate 1, raffinate 1P and raffinate 2), C₄ cuts from isobutane dehydrogenation, C₄ cuts from steamcrackers (after butadiene extraction or partly hydrogenated) and from FCC crackers (fluid catalyzed cracking), provided that they have been substantially freed of 1,3-butadiene present therein. Suitable C₄ hydrocarbon streams comprise generally less than 500 ppm, preferably less than 200 ppm, of butadiene. The presence of 1-butene and of cis- and trans-2-butene is substantially uncritical. Typically, the isobutene concentration in the C₄ hydrocarbon streams is in the range from 30 to 70% by weight, especially from 40 to 60% by weight, although raffinate 2 and FCC streams have lower isobutene concentrations but are equally suitable for the process according to the invention. The isobutenic monomer mixture may comprise small amounts of contaminants such as water, carboxylic acids or mineral acids without there being critical yield or selectivity losses. It is appropriate to the purpose to avoid enrichment of these impurities by removing such harmful substances from the isobutenic monomer mixture, for example by adsorption on solid adsorbents such as activated carbon, molecular sieves or ion exchangers.

The vinylic carbonyl compounds (“enophiles”) with the structural element C═C—C═O used may be corresponding α,β-unsaturated ketones, aldehydes or especially carboxylic acids. Examples of such enophiles are but-2-en-3-one, acrolein, crotonaldehyde, acrylic acid, methacrylic acid, maleic acid, fumaric acid or the anhydrides and esters thereof. The enophiles with the structural element C═C—C═O used may, for example, be propynoic acid, acetylenedicarboxylic acid or esters thereof. The enophiles with the structural element N═N—C═O used may, for example, be esters of azodicarboxylic acid.

In a preferred embodiment of the process according to the invention, the enophiles used are maleic acid, fumaric acid or the anhydrides thereof.

According to the invention, to prepare polyisobutylsuccinic anhydrides having an average molar ratio of succinic anhydride groups to polyisobutyl groups of from 1.0:1 to 1.3:1, the high-reactivity polyisobutenes mentioned are reacted with maleic acid or maleic anhydride in a molar ratio of from 1:3 to 1:0.95.

The high-reactivity polyisobutenes mentioned are, with regard to the stoichiometry, reacted with the enophile such as the maleic acid or the maleic anhydride in a manner known per se from the conventional thermal reaction by direct heating with an external heat source. The molar ratio of polyisobutenes to enophile such as maleic acid or maleic anhydride is from 1:3 to 1:0.95, preferably from 1:2 to 1:0.98, especially from 1:1.4 to 1:0.99, in particular from 1:1.2 to 1:1, i.e. usually a significant or a slight excess of enophile such as maleic acid or maleic anhydride is usually present in the reaction medium. Excess enophile such as unconverted maleic acid or unconverted maleic anhydride may, if required, be removed from the reaction mixture after the reaction has ended by extraction or distillation, for example by stripping with inert gas at elevated temperature and/or under reduced pressure. In the ideal case, the reaction is performed in an equimolar or approximately equimolar ratio of the two reactants owing to the reaction which proceeds virtually to completion.

The process according to the invention is performed generally at a reaction temperature in the range from 100 to 300° C., preferably in the range from 130 to 270° C., especially in the range from 150 to 250° C., in particular in the range from 160 to 220° C. The reaction time is typically from 30 minutes to 20 hours, preferably from 45 minutes to 10 hours, especially from 1 to 6 hours. Compared to corresponding ene reactions performed using conventional external heat sources, the reaction times may be shorter when microwave radiation is used.

The process according to the invention is generally performed with exclusion of oxygen and moisture in order to avoid undesired side reactions. However, the degree of reaction in the presence of atmospheric oxygen or a few ppm of halogen such as bromine may be higher than under inert conditions. However, preference is given to performing the reaction with appropriately purified reactants in an inert gas atmosphere, for example under dried nitrogen, since a subsequent filtration step can then normally be dispensed with owing to the relatively low formation of by-products.

In principle, the inventive reaction of the olefins with the vinylic carbonyl compounds can be performed in the absence of separate solvents or diluents. If desired, the process according to the invention can, though, also be performed in a solvent inert under the reaction conditions, for example in order to establish a suitable viscosity of the reaction medium or in order to avoid crystallization of enophile such as maleic acid or maleic anhydride at relatively cold points in the reactor. Examples of suitable solvents are aliphatic hydrocarbons and mixtures thereof, for example naphtha, petroleum or paraffins having a boiling point above the reaction temperature, and also aromatic hydrocarbons and halohydrocarbons, for example toluene, xylenes, isopropylbenzene, chlorobenzene or dichlorobenzenes, ethers such as dimethyldiglycol or diethyldiglycol and mixtures of the aforementioned solvents. The process products themselves are also useful as solvents.

When solvents, for example relatively nonpolar solvents, into which the microwave radiation is injected only weakly, such that a relatively sluggish heating characteristic for the reaction medium results, the heating can be accelerated by adding ionic liquids, usually in amounts of from 0.01 to 1% by weight, based on the remaining solvent, or by introducing a solid capable of injection, for example a silicon carbide shaped body, into the reaction medium.

If desired, the process according to the invention can be performed in the presence of at least one carboxylic acid as a catalyst. Useful carboxylic acids for this purpose—as described in document (4)—are especially aliphatic dicarboxylic acids having from 2 to 6 carbon atoms, for example oxalic acid, fumaric acid, maleic acid (in the case of the sole use of maleic anhydride as the reactant) or adipic acid. Esters of lower monocarboxylic acids, for example methyl propionate, can also be used as catalysts. The carboxylic acids or carboxylic acid derivatives mentioned can be added directly to the reaction mixture; in the case of maleic acid, it can also be formed from maleic anhydride under the reaction conditions by adding appropriate amounts of water. The amounts of catalyst here are generally from 1 to 10 mol %, especially from 3 to 8 mol %, based in each case on polyisobutene used.

The high-reactivity polyisobutenes and maleic acid or maleic anhydride may be mixed before the reaction and be converted by heating to the reaction temperature. In a further embodiment, only a portion of the maleic acid or of the maleic anhydride can be initially charged and the remaining portion of the reaction mixture can be added at reaction temperature such that a homogeneous phase is always present in the reactor. After the reaction has ended, the process product is worked up in a manner known per se; for this purpose, all volatile constituents are generally distilled off and the distillation residue is isolated. The polyisobutylsuccinic anhydrides prepared by the process according to the invention are obtained in tar-free or substantially tar-free form, which generally allows further processing of these products without further purification measures. In particular, compared to conventional heating with an external heat source, at least a significantly lower level of tarlike or cokelike deposits, if any, occurs on the inner walls of the reaction vessel. The content of undesired by-products (including dimaleated polyisobutylenes) in the reaction mixture itself is also significantly lower.

In a further preferred embodiment of the present invention, the reaction of the olefins with the vinylic carbonyl compounds is performed with use of microwave radiation, and the reaction vessel if simultaneously cooled externally by a flowing colder medium. Typically, the flowing colder medium used is a flowing liquid, especially a heat carrier liquid with high heat absorption capacity in the form of an oil, or a flowing gas, especially air, preferably in the form of compressed air. The flowing medium is appropriately passed through an external cooling jacket of the reaction vessel which is isolated from the actual reaction mixture. In the case of suitable selection of the flowing colder medium, it is not heated by the penetrating microwave radiation.

The PIBSAs prepared by the process according to the invention can be converted in a manner known per se by reaction with amines, alcohols or aminoalcohols typically with water elimination to corresponding polyisobutylsuccinic anhydride derivatives which have at least one primary or secondary amino group, an imino group and/or a hydroxyl group. Such derivatives are suitable as additives in fuel and lubricant compositions. These derivatives are usually monoamides, amides, imides, esters or mixed amide esters of the polyisobutylsuccinic acids. Imides are of particular interest in this case. In the case of use of amines or amino alcohols, the second unamidated or unesterified carboxyl group may also be present in the derivatives in the form of the corresponding ammonium carboxylates.

In the case of amines as reactants, they are preferably compounds capable in principle of imide formation, i.e., as well as ammonia, compounds having one or more primary or secondary amino groups. It is possible to use mono- or dialiphatic amines, cycloaliphatic amines or aromatic amines. Of particular interest are polyamines, especially aliphatic polyamines having from 2 to 10, in particular from 2 to 6, nitrogen atoms, having at least one primary or secondary amino group. These aliphatic polyamines bear alkylene groups such as ethylene, 1,2-propylene or 2,2-dimethylpropylene; examples of such compounds are ethylenediamine, diethylenetriamine, triethylenetetramine, tetraethylenepentamine, pentaethylenehexamine, dipropylenetriamine, tripropylenetetramine and N,N-dimethylpropylene-1,3-diamine.

Further polyamines suitable for reaction with the PIBSAs prepared in accordance with the invention are, for example, also N-amino-C₁-C₆-alkylpiperazines such as 4-(2-aminoethyl)piperazine.

Amines likewise suitable for reaction with the PIBSAs prepared in accordance with the invention are, for example, monoalkylamines and alkyleneamines in which the alkyl or alkylene radicals are interrupted by one or more nonadjacent oxygen atoms which may optionally also have hydroxyl groups and/or further amino groups, for example 4,7-dioxadecane-1,10-diamine, 2-(2-aminoethoxy)ethanol or N-(2-aminoethyl)ethanolamine.

Alcohols suitable for reaction with the PIBSAs prepared in accordance with the invention are, for example, di- or polyols having preferably from 2 to 5 hydroxyl groups, for example ethylene glycol, glycerol, diglycerol, triglycerol, trimethylolpropane, pentaerythritol and ethoxylated and/or propoxylated derivatives of these di- or polyols.

Amino alcohols suitable for reaction with the PIBSAs prepared in accordance with the invention are, for example, alkanolamines such as ethanolamine and 3-aminopropanol.

Also suitable for reaction with the PIBSAs prepared in accordance with the invention are ethoxylated and/or propoxylated derivatives of the amines and amino alcohols mentioned.

The molar ratio of PIBSAs to the amines, alcohols or amino alcohols mentioned in the reaction is generally in the range from 0.4:1 to 4:1, preferably from 0.5:1 to 3:1. In the case of compounds having only one primary or secondary amino group, frequently at least equimolar amounts of amine will be used.

In the case of use of primary amines, reaction with the maleic anhydride moiety can form amide and/or imide structures, in which case the reaction conditions are preferably selected so as to form imide structures, since the products obtained in this case are preferred owing to their better performance properties.

Amines having two amino groups, preferably having two primary amino groups, are also capable of forming corresponding bisamides or bisimides. To prepare the bisimides, the amine will preferably be used in about the stoichiometry needed for this purpose. Typically, the diamines are used in this case in an amount of less than 1 mol, especially in an amount of from 0.3 to 0.95 mol, in particular in an amount of from 0.4 to 0.9 mol, per mole of PIBSA.

According to the reactivity of the selected reactants, the reaction of the PIBSAs with the amines, alcohols or amino alcohols mentioned is performed normally at a temperature in the range from 25 to 300° C., especially in the range from 50 to 200° C., in particular in the range from 70 to 170° C., if appropriate using a customary amidation catalyst. Excess amine or excess alcohol or amino alcohol can, if appropriate, after the reaction has ended, be removed from the reaction mixture by extraction or distillation, for example by stripping with inert gas at elevated temperature and/or under reduced pressure. Preference is given to performing the reaction up to a conversion of the components of at least 90%, especially 95% (based in each case on the component used in deficiency), and the reaction progress can be monitored with reference to the water formation by means of customary analytical methods, for example via the acid number. The formation of compounds with imide structure from those with amide structure can be monitored by means of infrared spectroscopy.

The PIBSA derivatives described are notable for improved viscosity behavior with at least comparable dispersing action to corresponding commercial products with comparable number-average molecular weight. They may therefore be used in higher concentrations in lubricant compositions than the commercial dispersants mentioned without any risk of disadvantages in the viscosity behavior of the lubricant, which is of interest especially with regard to prolonged oil change intervals.

Lubricant compositions shall be understood here to mean all customary, generally liquid, lubricant compositions. The economically most significant lubricant compositions are motor oils, and also transmission oils including manual and automatic oils. Motor oils consist typically of mineral base oils which comprise predominantly paraffinic constituents and are prepared by complicated workup and purification processes in the refinery and have a content of normally from approx. 2 to 10% by weight of additives (based on the active substance contents). For specific applications, for example high-temperature uses, the mineral base oils may be replaced partly or fully by synthetic components such as organic esters, synthetic hydrocarbons such as olefin oligomers, poly-α-olefins or polyolefins or hydrocracking oils. Motor oils must also have sufficiently high viscosities at high temperatures in order to ensure an impeccable lubrication effect and a good seal between cylinder and piston. Moreover, the flow properties of motor oils must also be such that the engine can be started without any problem at low temperatures. Motor oils must be oxidation-stable and must generate only a low level of decomposition products in liquid or solid form and deposits even under severe working conditions. Motor oils disperse solids (dispersant behavior), prevent deposits (detergent behavior), neutralize acidic reaction products and form a wear protection film on the metal surfaces in the motor. Motor oils for internal combustion engines, especially for gasoline engines, Wankel engines, two-stroke engines and diesel engines, are typically characterized by viscosity classes (SAE classes); of particular interest in this context are fuel-economy motor oils, especially of viscosity classes SAE 5 W to 20 W to DIN 51511.

With regard to their base components and additives, transmission oils including manual and automatic oils are of similar composition to motor oils. The force is transmitted in gear systems of transmissions to a high degree through the liquid pressure in the transmission oil between the teeth. The transmission oil accordingly has to be such that it withstands high pressures over time without decomposing. In addition to the viscosity properties, wear, pressure resistance, friction, shear stability, traction and run-in performance are the crucial parameters here.

The lubricant compositions mentioned comprise the PIBSA derivatives described in an amount of typically from 0.001 to 20% by weight, preferably from 0.01 to 10% by weight, especially from 0.05 to 8% by weight and in particular from 0.1 to 5% by weight, based on the total amount of the lubricant composition.

The lubricant compositions mentioned may be additized in a customary manner, i.e., as well as the base oil components typical of their end use, such as mineralic or synthetic hydrocarbons, polyethers or esters or mixtures thereof, they also comprise customary additives other than dispersants, such as detergent additives (HD additives), antioxidants, viscosity index improvers, pour point depressants (cold flow improvers), extreme pressure additives, friction modifiers, antifoam additives, corrosion inhibitors (metal deactivators), emulsifiers, dyes and fluorescent additives, preservatives and/or odor improvers in the amounts customary for this purpose. It will be appreciated that the PIBSA derivatives described in the lubricant compositions may also be used together with other additives with dispersing action, especially with ashless additives with dispersing action, the proportion of the PIBSA derivatives described in the total amount of the dispersing additives being generally at least 30% by weight, especially at least 60% by weight.

The PIBSA derivatives described also find use as detergents in fuel compositions, especially in gasoline fuels and middle distillate fuels, and in this application reduce or prevent deposits in the fuel system and/or combustion system of engines, especially gasoline and diesel engines.

Useful gasoline fuels include all customary gasoline fuel compositions. A typical representative which shall be mentioned here is the Eurosuper base fuel to DIN EN 228 which is customary on the market. In addition, gasoline fuel compositions of the specification according to WO 00/47698 are also possible fields of use for the present invention.

Useful middle distillate fuels include all customary diesel fuel and heating oil compositions. Diesel fuels are typically crude oil raffinates which generally have a boiling range of from 100 to 400° C. These are usually distillates having a 95% point up to 360° C. or even higher. However, they may also be so-called “Ultra low sulfur diesel” or “City diesel”, characterized by a 95% point of, for example, not more than 345° C. and a sulfur content of not more than 0.005% by weight, or by a 95% point of, for example, 285° C. and a sulfur content of not more than 0.001% by weight. In addition to the diesel fuels obtainable by refining, whose main constituents are relatively long-chain paraffins, those obtainable by coal gasification or gas liquefaction [“gas-to-liquid” (GTL) fuels] are suitable. Also suitable are mixtures of the aforementioned diesel fuels with renewable fuels such as biodiesel or bioethanol. Of particular interest at the present time are diesel fuels with a low sulfur content, i.e. with a sulfur content of less than 0.05% by weight, preferably of less than 0.02% by weight, in particular of less than 0.005% by weight and especially of less than 0.001% by weight of sulfur. Diesel fuels may also comprise water, for example in an amount up to 20% by weight, for example in the form of diesel-water microemulsions or as so-called “white diesel”.

Heating oils are, for example, low-sulfur or sulfur-rich crude oil raffinates, or bituminous coal distillates or brown coal distillates, which typically have a boiling range of from 150 to 400° C. Heating oils may be standard heating oil to DIN 51603-1, which has a sulfur content of from 0.005 to 0.2% by weight, or they are low-sulfur heating oils having a sulfur content of from 0 to 0.005% by weight. Examples of heating oil include especially heating oil for domestic oil-fired boilers or EL heating oil.

The PIBSA derivatives described can be added either to the particular base fuel, especially to the gasoline fuel or to the diesel fuel, alone or in the form of fuel additive packages, for example the so-called gasoline or diesel performance packages. Such packages are fuel additive concentrates and generally comprise, as well as solvents, also a series of further components as coadditives, for example carrier oils, cold flow improvers, corrosion inhibitors, demulsifiers, dehazers, antifoams, cetane number improvers, combustion improvers, antioxidants or stabilizers, antistats, metallocenes, metal deactivators, solubilizers, markers and/or dyes in the amounts customary therefor. It will be appreciated that the PIBSA derivatives described may also be used in the fuel compositions together with other additives with detergent action, in which case the proportion of the PIBSA derivatives described in the total amount of additives with detergent action is generally at least 30% by weight, especially at least 60% by weight.

The fuel compositions mentioned comprise the PIBSA derivatives described in an amount of typically from 10 to 5000 ppm by weight, preferably from 20 to 2000 ppm by weight, especially from 50 to 1000 ppm by weight and in particular from 100 to 400 ppm by weight, based on the total amount of the fuel composition.

The process according to the invention for preparing ene adducts, especially polyisobutylsuccinc anhydrides, is notable for higher conversions, purer products and more uniform product structures, which also positively influences the subsequent conversion of the PIBSAs to the corresponding derivatives suitable as fuel and lubricant additives, and enhances their quality, especially the active substance content in these derivatives. For instance, the PI BSA derivatives obtained therefrom are notable especially for improved viscosity behavior with at least comparable dispersing action to corresponding commercial products with comparable number-average molecular weight. They can therefore be used in higher concentrations in lubricant compositions than the commercial dispersants mentioned without any risk of disadvantages in the viscosity behavior of the lubricant, which is of interest especially with regard to prolonged oil change intervals.

In particular, however, the generally undesired formation of enes reacted twice with the enophile component, especially of dimaleated polyisobutenes, can be controlled or suppressed. Moreover, the PIBSAs prepared by the process according to the invention are obtained in tar-free or substantially tar-free form, which generally allows further processing of these products without further purification measures, such as filtering off the tar particles.

The examples which follow are intended to illustrate the present invention without restricting it.

### EXPERIMENT 1 TO 5

### Preparation of Polyisobutylsuccinic Anhydride

The amounts of high-reactivity polyisobutene (“PIB”) (Glissopal® 1000 from BASF Aktiengesellschaft: Mₙ=1000, content of α-double bonds: 80 mol %) and maleic anhydride (“MA”) specified in each case in the table below were heated in a 20 ml microwave vessel from Biotage to 70° C. in a waterbath, so as to obtain a low-viscosity stirrable emulsion. This emulsion was in each case subsequently introduced directly into a closed Biotage initiator 2.0 8EXP microwave reactor (frequency used: 2.45 GHz) and stirred there at 330 revolutions per minute for 1 minute. Subsequently, the sample was in each case irradiated with a power of 400 watts for 30 minutes to heat it; a temperature of 210° C. was established in each case (measured by IR spectroscopy on the inner vessel surface of the reactor). This temperature was in each case maintained by continuing the irradiation for a further 5½ hours with stirring at the abovementioned speed, in the course of which the irradiation output to maintain the temperature leveled off at approx. 100 watts. Thereafter, the sample was in each case brought to below 50° C. by external cooling with compressed air and worked up (inventive experiments 3 to 5).

For comparison, polyisobutylsuccinic anhydride was also prepared from the same reactants by conventional heating with stirring for 6 hours in a closed flask with a heating bath to 210° C. (measured with an internal thermometer immersed into the reaction medium) (comparative experiments 1 and 2).

The table below shows the particular use amounts and the results of the experiments:

| | Exp. No.: | | | | |
|---|---|---|---|---|---|
| | 1 | 2 | 3 | 4 | 5 |
| Amount of PIB [g] | 17 | 17 | 17 | 17 | 17 |
| Amount of MSA [g] | 2.0 | 2.3 | 2.0 | 2.3 | 1.6 |
| Mol. PIB:MA ratio | 1:1.2 | 1:1.4 | 1:1.2 | 1:1.4 | 1:1.0 |
| Residue formation | little | a lot | none | none | none |
| PIB conversion [%] | 67 | 82 | 81 | 85 | 77 |
| Active acidic groups | 75 | 99 | 92 | 103 | 80 |
| [mg KOH/g] | | | | | |
| Proportion of bismaleation product | 11 | 19 | 13 | 16 | 2 |
| [% by wt.] | | | | | |

In the inventive microwave-supported experiments 3 to 5, in contrast to comparative experiments 1 and 2, no tarlike or cokelike residues were found on the inner wall of the reaction vessel.

On comparison of the results of comparative experiment 1 and of the corresponding inventive experiment 3, the proportion of undesired bismaleation product (dimaleated polyisobutylenes) is slightly higher in the microwave-supported synthesis, but this is not surprising given the significantly higher conversion (and hence significantly higher content of active acidic groups) in the case of inventive experiment 3, since the proportion of bismaleation product generally rises with the conversion.

On comparison of the results of comparative experiment 2 and the corresponding inventive experiment 4, in contrast, a proportion of undesired bismaleation product is lower in the microwave-supported synthesis even at a higher conversion.

The lowest proportion of undesired bismaleation product in the microwave-supported synthesis is achieved in the case of equimolar use of PIB and MA (inventive experiment 5).

1-9. (canceled)

10. A process for preparing ene adducts by thermal reaction of olefins (“enes”) with vinylic carbonyl compounds (“enophiles”), the enes used being high-reactivity polyisobutenes having a number-average molecular weight Mₙ of from 350 to 50 000, and a content of at least 70 mol % of α-double bonds, which comprises performing the reaction using microwave radiation.

11. The process for preparing ene adducts according to claim 10, wherein the enophiles are selected from the group consisting of maleic acid, fumaric acid and the anhydrides thereof.

12. The process for preparing ene adducts according to claim 10, in which polyisobutylsuccinic anhydrides having an average molar ratio of succinic anhydride groups to polyisobutyl groups of from 1.0:1 to 1.3:1 are prepared by reacting the high-reactivity polyisobutenes with maleic acid or maleic anhydride in a molar ratio of from 1:3 to 1:0.95.

13. The process for preparing ene adducts according to claim 10 by thermally reacting the enes with the enophiles at temperatures of from 100 to 300° C.

14. The process for preparing ene adducts according to claim 10, wherein the reaction is performed in a closed reaction vessel.

15. The process for preparing ene adducts according to claim 10, wherein the reaction is performed using microwave radiation and the reaction vessel is simultaneously cooled externally by a flowing colder medium.
